(19) United States
(12) Patent Application Publication
(10) Pub. No.: US 2006/0124066 A1
(43) Pub. Date: Jun. 15, 2006

(54) Teat dip monitoring system

(75) Inventor: Forest S. Mitchell, Brighton, CO (US)

Correspondence Address: DORR, CARSON & BIRNEY, P.C.;ONE CHERRY CENTER, 501 SOUTH CHERRY STREET, SUITE 800, DENVER, CO, 80246, US

(73) Assignee: TF Products LLC

(21) Appl. No.: 11/010,023

(22) Filed: Dec. 10, 2004

(51) Int. Cl. A01J 3/00

(52) U.S. Cl. 119/14.14

(57) ABSTRACT

A system monitors use of teat dip for each sprayer in a dairy. Sensors detect the flow of teat dip through the supply lines to each sprayer. A processor monitors the sensors and stores sensor data over a period of time. A wide variety of reports concerning use of teat dip can be generated from this sensor data.

### BACKGROUND OF THE INVENTION

1. Field of the Invention

The present invention relates generally to the field of dairy operations. More specifically, the present invention discloses a system for monitoring use of teat dip at milking parlors in a dairy.

2. Statement of the Problem

Fighting infection is a constant battle for dairymen. A dairy's somatic cell count (or SCC) is the count of bacteria in the final milk product. SCC levels are monitored to assure compliance with state and federal milk quality standards. Although there is a maximum SCC specified by law for milk to be of a quality to be sold to milk plants, milk with elevated SCC levels (but well below the legal limit) will not draw the premium prices that low SCC milk will. Decreased shelf life is a common result of an elevated SCC score. Additionally, even a slight elevation in SCC levels can cause a decrease in milk production. In addition, the dairy may have to sell some of the cows with very high SCC scores. If the SCC is higher than the legal limit, milk plants will either refuse to pick up the milk, or at least change it to a much lower grade than grade A. This will result in another financial loss to the dairyman.

One of the dairyman's major tools in fighting these bacteria (beyond general cleanliness) is to apply a disinfectant spray to the cows' teats. This is typically done immediately before each cow is attached to the milking machine and right after the milking machine comes off the cow. This disinfectant is known in the industry as “teat dip.” Teat dip is applied by various means, including handheld sprayers and dip cups held by the milker. When teat dip is applied, it is critical that the proper amount be applied for it to have the desired effect in killing any and all germs. Unfortunately, the milkers are not usually not paid well and often do not have much concern for the overall operation of the dairy. This lack of concern and a high turnover rate can result in milkers taking shortcuts, including improper application of teat dip or skipping some of the teat dip applications. Heretofore, there has been no way for the dairy owner to monitor how well the teat dip has been applied, especially when there is not a supervisor available to watch the milkers. Therefore, a need exists for a system to monitor application of teat dip to ensure proper disinfection by milkers.

3. Solution to the Problem

The present invention provides a system to monitor the teat dipping process. For example, the present invention can be used to monitor the amount of teat dip used in each milking, the number of times each sprayer is used per milking, and the length of time each sprayer is used. The present system can also store such data over longer periods of time to generate graphs, reports and statistical summaries by shift, day, week, month, or year.

### SUMMARY OF THE INVENTION

This invention provides a system for monitoring use of teat dip by each sprayer in a dairy. Sensors detect the flow of teat dip through the supply lines to each sprayer. A processor monitors the sensors and stores sensor data over a period of time. A wide variety of reports concerning use of teat dip can be generated from this sensor data.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a schematic overview of the monitoring system.

FIG. 2 is a diagram of the teat dip supply line 15, sensor 30 and sprayer 17 for a typical milking parlor 20.

FIG. 3 is an example of a daily summary report generated by the monitoring system.

FIG. 4 is an example of a report providing statistics on dip usage by shift over a period of seven days.

FIG. 5 is an example of a graph showing total dip usage by shift over a period of six days.

FIG. 6 is an example of a graph showing the total number of dips or spray (TDS) per shift over a period of seven days.

FIG. 7 is an example of a graph showing the total number dips or sprays for one shift over the period of a month.

### DETAILED DESCRIPTION OF THE INVENTION

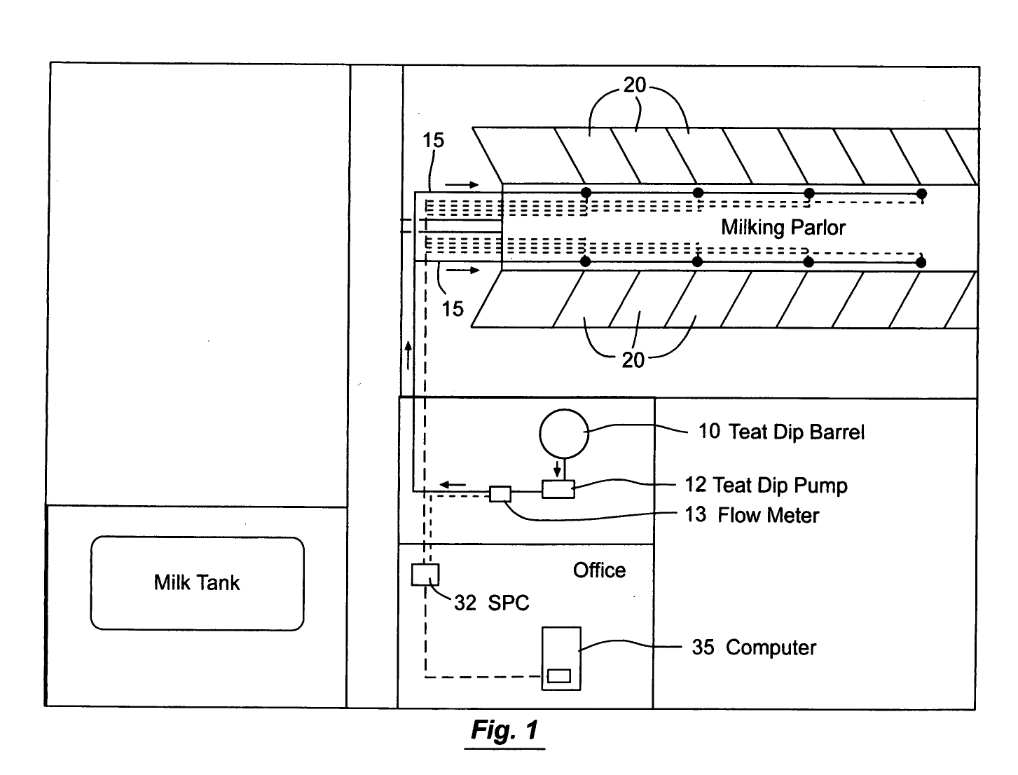

Turning to FIG. 1, a schematic overview is provided of the present monitoring system installed in a milking parlor. The dairy has a number of milking stations 20 with milking equipment that collects milks in a milk tank. The dairy is also equipped with a number of sprayers for dispensing teat dip to disinfect the cows udders before and after milking. It should be expressly understood that the term “sprayer” should be broadly construed to cover all types of dispensing devices, including teat dip cups. In addition, the term “teat dip” should be broadly construed to include all types of disinfectant and cleaning solutions used in dairies.

The teat dip is typically stored in a central barrel or tank 10 and is supplied by a pump 12 through supply lines 15 to the milking parlor. Optionally, a master flow meter 13 in the main supply line can be used to monitor the total usage of teat dip by the entire milking parlor. Throughout the milking parlor, there are a series of drop lines 16 from the main supply lines 15 with a spray handle 17 at the end of each drop line 16 to spray the disinfectant fluid on the teats of the milking cows.

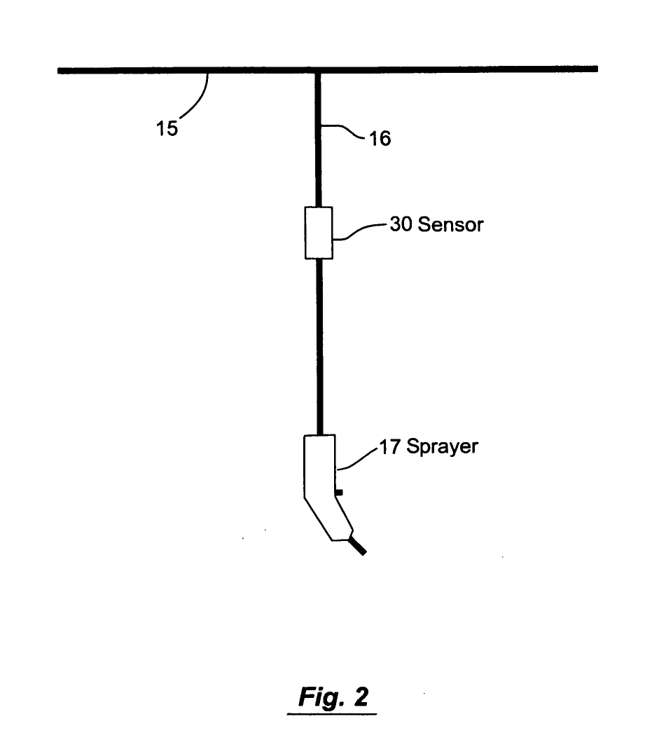

In the present monitoring system, sensors 30 (e.g., flow meters or flow switches) are inserted in the teat dip supply lines to each sprayer 17. Preferably, the sensor is inserted in the drop line 16 adjacent to the point at which the drop line 16 connects to the main supply line 15. FIG. 2 is a diagram is provided of the teat dip supply line 15, drop line 16, sensor 30 and sprayer 17 for a typical milking parlor.

The sensors 30 are monitored by a processor (e.g., a computer). For example, if a flow switch is employed, the flow switch closes a contact that is detected by the processor as long as fluid is flowing in the line. In this embodiment, the processor monitors the sensors 30 to determine how long each sprayer 17 stays on and the number of times it is used. Alternatively, a flow switch could be placed in the handle of each sprayer 17. However, this configuration adds complexity and is undesirable because it fails to keep all electrical currents as far away from the cow as possible. In another embodiment, a flow meter could be used as the sensor 30 in each drop line 16.

The preferred embodiment of the present invention employs a local processor 32, such as a general-purpose single board computer (SBC) to monitor the sensors 30 and periodically upload sensor data to a main processor 35. A monitoring program runs on the SBC 32 that handles the low-level hardware monitoring of the sensors 30. Flow switches are monitored by a polling loop, and flow meters are monitored through interrupt service routines. The monitoring program also includes diagnostics and calibration routines that are useful for the system installer.

The amount of dip use in the milking parlor can be determined in a variety of ways. If the sensor 30 is a flow switch, the flow rate is pre-measured and usage is calculated by multiplying the flow rate by the time of flow. Alternatively, if the sensor 30 is a flow meter, the flow rate is measure directly. The sensors 30 are connected to the SBC 32 via an interface board that provides termination of field wiring and power supply to the unit. Data is initially collected in the system RAM on the SBC 32 and uploaded to the main computer 35 on a periodic basis (e.g., daily) for analysis and reporting. A battery backup is provided to enable the SBC 32 to remain operational and prevent the loss of data in the event of power failure. All field wiring is preferably operated at TTL voltage levels (5V) and kept as far as possible from the cows to minimize any potential problems with stray current interference.

For example, the SBC 32 can be a commercially-available PC/104 form factor embedded computer with a 12 MHz 80C188EB CPU. Enough RAM should be provided to meet data storage needs for the installation, typically 512 KB. 128 KB of flash RAM is provided for the firmware. One RS-232 serial port is provided for program monitoring and data transfer, and a second port is provided for firmware upgrades. An 82C44 device is used to monitor up to twelve flow switches. Up to five flow meters can be connected to the PC/104 system bus and generate system interrupts proportional to the rate of fluid flow through the lines being monitored. It should be understood that other communications methods and protocols could be readily substituted. For example, the sensors could communicate with the processor via a wireless network, such as a conventional Wi-Fi or Bluetooth network. Any of a variety of conventional wired networks could also be employed. The sensors can also communicate with the processor via a conventional USB or Firewire interface.

An alternative implementation could use a custom microprocessor board designed specifically for this application, rather than a general purpose SBC 32. While this implementation would be less costly to implement, it suffers from the problem that it is less flexible and harder to make changes once it has been developed. Additionally, if the installation were to require monitoring more than twelve flow switches or more than five flow meters, additional SBCs could be installed to meet the need. The interface board could also be readily redesigned to allow for the connection of more sensors.

Data is stored by the SBC 32 and transferred to the main processor 35 on an periodic basis. The processor 35 has data storage (e.g., a hard disk) that enables it to store sensor data over extended periods of time. For example, the main processor 35 can be conventional personal computer or server equipped with data analysis and report generation software. The sensor data can be used to calculate how much teat dip is used by each milking shift at each sprayer 17, the total number of times that each sprayer was used, and the length of time each sprayer was used. The dairyman is able to look at the data for each sprayer separately for the number of times the sprayer was used, and the average time the sprayer stayed on. In this manner, the dairy operator can see if each milker had enough sprays in the shift, and if each sprayer has stayed on long enough.

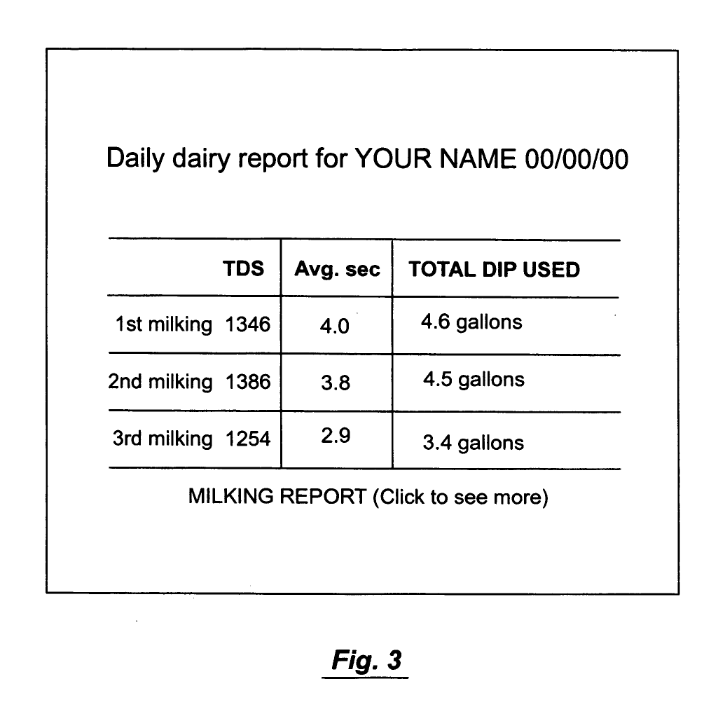

As shown in FIGS. 3-7, report generation software can be employed to generate a wide variety of graphs and reports to allow the dairy operator to see the amount of time each sprayer was operated and the amount of dip used on a periodic basis throughout the day. The time periods can be selected to allow the dairyman to control the amount of data to be reviewed, from rough overall summaries or even minute-by-minute reports. For example, summaries are also available by shift, day, week, month, year, milker, or sprayer.

FIG. 3 is an example of a daily summary report generated by the present monitoring system. This report shows the total number of dips or sprays (TDS), the average duration of each spray, and the total amount of dip used during each milking shift. Report fields can be printed in red, highlighted or otherwise flagged to call special attention to numbers that are outside of normal parameters or predetermined limits.

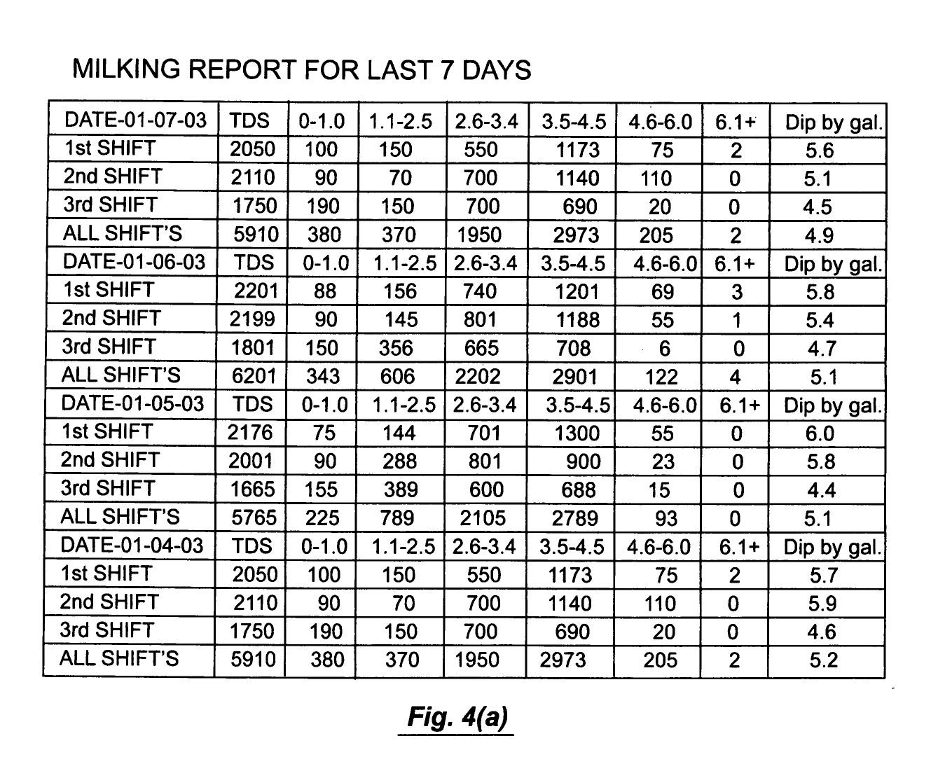

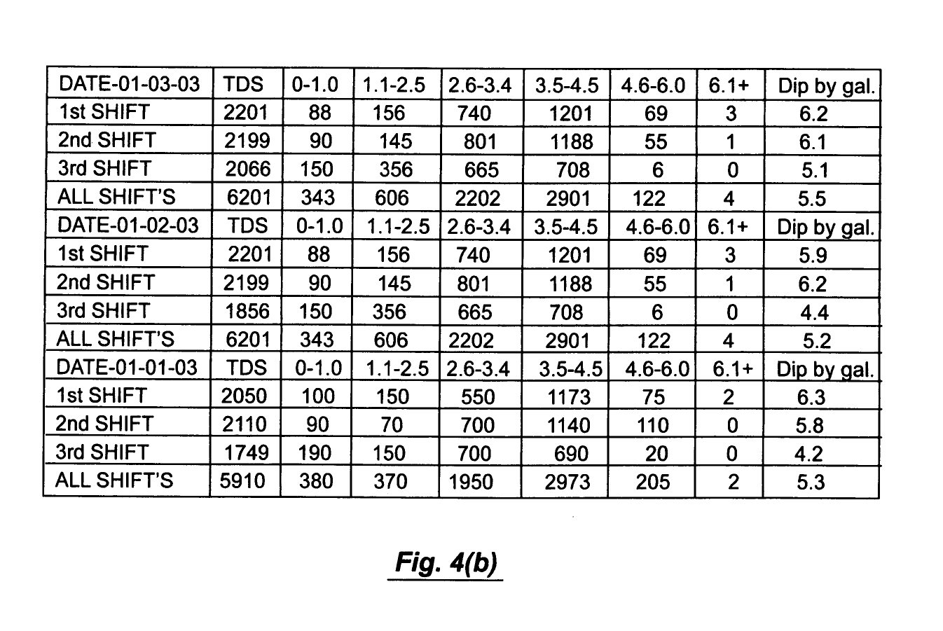

FIG. 4 is an example of a report providing statistics on dip usage by shift over a period of seven days. Here again, the report shows the total number of dips or sprays, and the total amount of dip used during each milking shift on each day. However, the duration of each spray is provided as a distribution over a range of time increments.

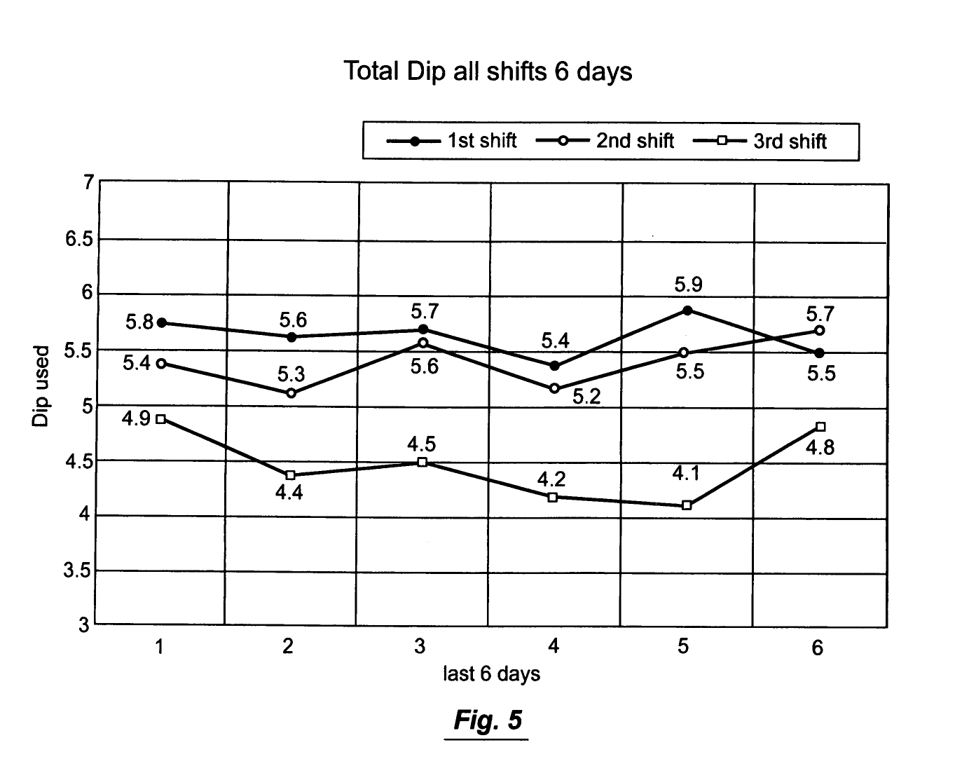

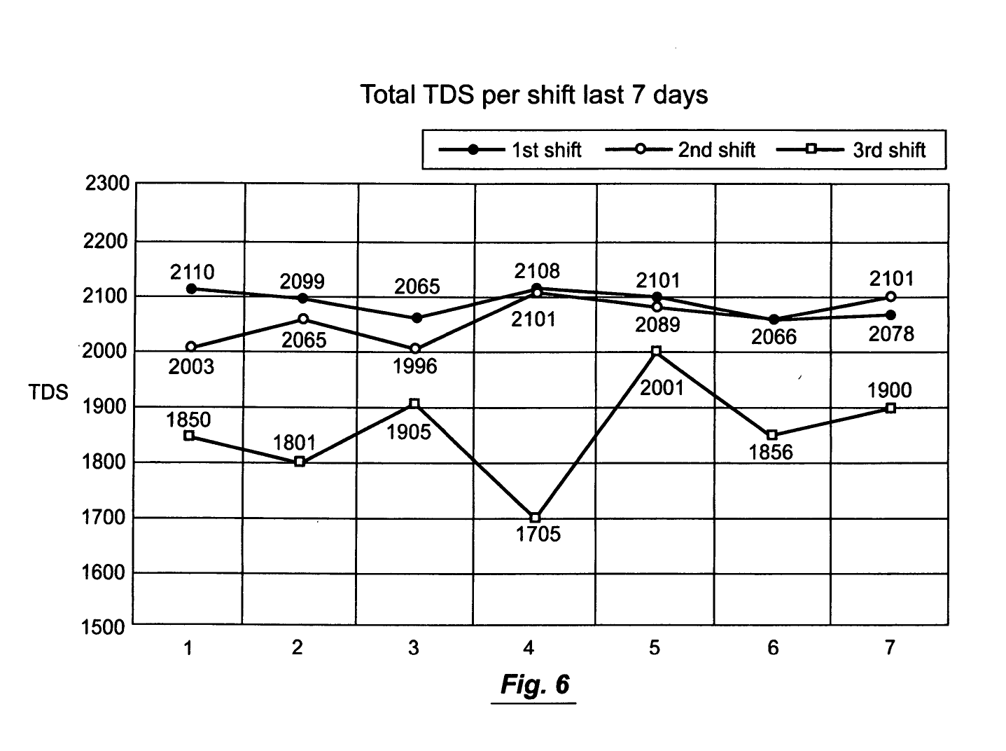

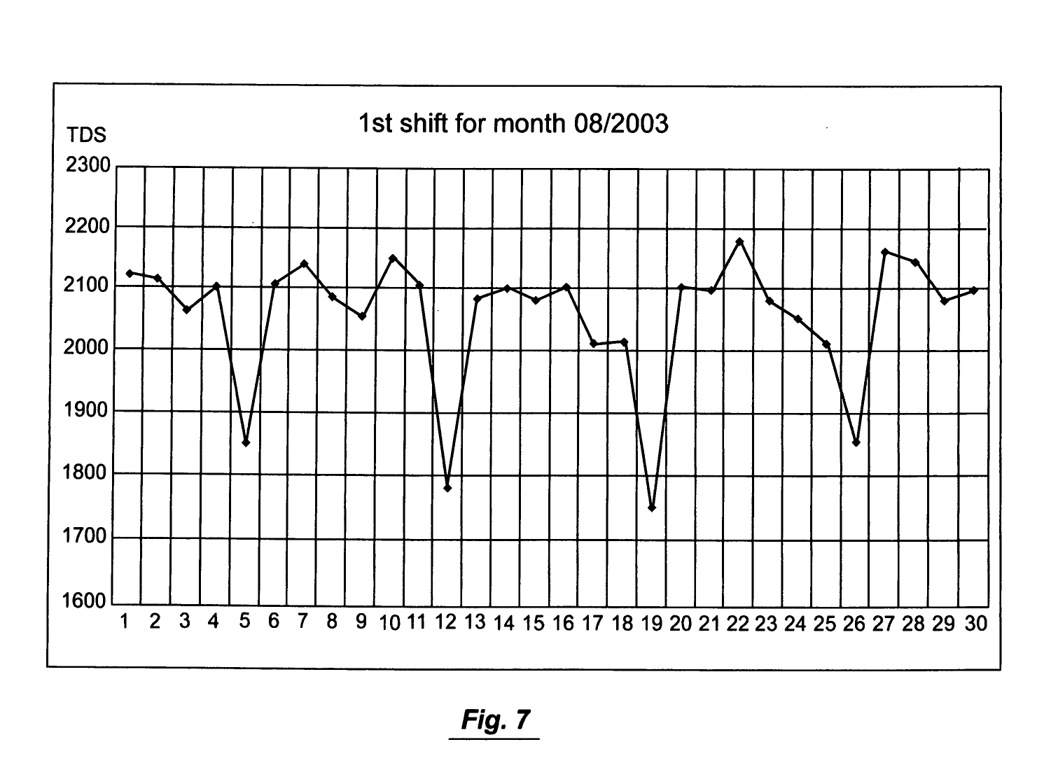

FIGS. 5-7 are examples of graphs that can be generated. In particular, FIG. 5 is an example of a graph showing total dip usage by shift over a period of six days. FIG. 6 is an example of a graph showing the TDS per shift over a period of seven days. FIG. 7 is an example of a graph showing the TDS for one shift over the period of a month. A wide range of other types of graphs could also be generated.

It should be understood that the present monitoring system is not limited to specific computer architecture shown in FIG. 1. For example, the present invention could be implemented with a single processor, or in LAN or WAN-based architecture. An internet-based architecture could also be use. In addition, a wide variety of data manipulation and report generation tools could be employed, such as database management software, statistical analysis software, and spreadsheets.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

I claim:

1. A system for monitoring use of teat dip in a dairy having a plurality of manually-actuated sprayers for dispensing teat dip, said system comprising:
a plurality of sensors, each sensor detecting actuation of a sprayer;
a processor monitoring the sensors and storing sensor data over a period of time; and
a report generator producing reports concerning use of teat dip from the data stored by the processor.

2. The system of claim 1 wherein the report generator produces reports summarizing use of teat dip at each sprayer for a specified period of time.

3. The system of claim 1 wherein the report generator produces reports concerning the number of times that teat dip was dispensed during a specified period of time.

4. The system of claim 1 wherein the report generator produces reports concerning the length of time that teat dip was dispensed over a specified period of time.

5. The system of claim 1 wherein the report generator produces reports summarizing the total amount of teat dip used over a specified period of time.

6. The system of claim 1 further comprising a main processor providing the report generator, wherein sensor data is periodically uploaded from the processor to the main processor for storage and report generation.

7. A system for monitoring use of teat dip in a dairy having supply lines and a plurality of manually-actuated sprayers for dispensing teat dip, said system comprising:
a plurality of flow meters, each flow meter measuring the flow of teat dip through a supply line to a sprayer;
a processor monitoring the flow meters and storing flow data over a period of time; and
a report generator producing reports concerning use of teat dip from the flow data stored by the processor.

8. The system of claim 7 wherein the report generator produces reports summarizing use of teat dip for a specified period of time.

9. The system of claim 7 wherein the report generator produces reports concerning the number of times that teat dip was dispensed during a specified period of time.

10. The system of claim 7 wherein the report generator produces reports concerning the length of time that teat dip was dispensed over a specified period of time.

11. The system of claim 7 wherein the report generator produces reports concerning the amount of teat dip dispensed over a specified period of time.

12. The system of claim 7 further comprising a main processor providing the report generator, wherein flow data is periodically uploaded from the processor to the main processor for storage and report generation.

13. A system for monitoring use of teat dip in a dairy having supply lines and a plurality of manually-actuated valve for dispensing teat dip, said system comprising:
a plurality of sensors, each sensor detecting the flow of teat dip through a supply line to a sprayer;
at least one local processor monitoring a set of the sensors and storing sensor data over a period of time; and
a main processor in communications with each local processor to upload sensor data and having a report generator producing reports concerning use of teat dip from the sensor data.

14. The system of claim 13 wherein at least one of the sensors detects actuation of a sprayer.

15. The system of claim 13 wherein at least one of the sensors comprises a flow meter in the supply line to a sprayer.

16. The system of claim 13 wherein the report generator produces reports summarizing use of teat dip for a specified period of time.

17. The system of claim 13 wherein the report generator produces reports concerning the number of times that teat dip was dispensed during a specified period of time.

18. The system of claim 13 wherein the report generator produces reports concerning the length of time that teat dip was dispensed over a specified period of time.
